(19) United States
(12) Patent Application Publication
(10) Pub. No.: US 2015/0198474 A1
(43) Pub. Date: Jul. 16, 2015

(54) BARREL BUNG WIRELESS SENSOR PACK

(71) Applicant: Gregory M. Howard, Reno, NV (US)

(72) Inventor: Gregory M. Howard, Reno, NV (US)

(21) Appl. No.: 14/597,088

(22) Filed: Jan. 14, 2015

Related U.S. Application Data
(60) Provisional application No. 61/927,804, filed on Jan. 15, 2014.

(51) Int. Cl. G01F 23/00; C12G 3/00; C12G 1/00

(52) U.S. Cl. CPC G01F 23/0061; C12G 1/00; C12G 3/00

(57) ABSTRACT

An aging barrel such as for wine, whiskey and the like may include a sensor assembly disposed in the bung for sensing parameters from within the barrel. A transceiver sends the signals to a computer system which analyzes the signals and determines if the parameters of the barrel have reached or are trending toward an abnormal barrel profile. Alerts may be sent to end users, e.g. via SMS or email, to enable corrective action to be taken. In one example, a temperature profile of multiple barrels within a storage facility may be obtained and barrels may be moved to achieve desired temperature characteristics.

### CROSS REFERENCE TO RELATED APPLICATIONS

This application claims priority to U.S. provisional patent application Ser. No. 61/927,804, filed 15 Jan. 2014, the contents of which is herein incorporated by reference.

### FIELD OF THE INVENTION

The present invention relates to systems and methods for making alcoholic beverages such as wine and spirits and the like.

### BACKGROUND

Much of the quality wine and whiskey produced in the world is aged in oak barrels to increase the flavor and quality. During the wine and whiskey aging process in oak barrels, wine and whiskey evaporates slowly through the oak wood lowering the wine level within the barrel. During the aging process, significant amounts of oxygen is damaging to the quality of wine and whiskey. Wine and whiskey benefit from the micro-oxidation process that occurs through the porous organic structure of the oak wood, however gross amounts of oxygen are potentially damaging to the wine or whiskey. As the level of wine lowers within an oak barrel, the space that fills up with air is known as the barrel head space. Winemakers and whiskey makers periodically check the level of contents of the barrel, topping up the barrel with additional wine or whiskey to reduce headspace and the destructive effect of oxygen to wine. Additionally, small imperfections in barrels can lead to slow leaking—causing headspace to increase at unpredictable levels.

The common practice in the wine industry is to use a random sampling of barrels to identify abnormal aging conditions, such as oxidation, abnormal sulfite levels, fluid loss, and other issues. The current method for monitoring wine and whiskey barrel condition and fluid level is a manual process where a technician visually looks into a barrel and logs temperature. With wine and whisky making, much of the science used is dedicated to crafting a particular type of wine or whisky. Random sampling is not suitable for maintaining fermentation and aging parameters at their most desirable levels.

Another factor that affects wine and whiskey production is temperature. The general method for monitoring temperature within a wine and whiskey aging facility is a temperature controlled room or warehouse. The temperature is controlled through standard Heating Ventilation and Air Conditioning (HVAC). Placement of HVAC ducting equipment is often designed for air flow from one end of a room to the other, with the goal of efficiency in mind. However, wine and whiskey barrels positioned near HVAC ducting may receive significant amounts of warm or cold air, changing the temperature during the wine aging process. The number of temperature changes is increased with the number of times HVAC equipment cycles to heat or cool the room temperature.

What is required is an improved system and method for monitoring wine and whiskey production.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to monitor an aging process of an alcohol product.

the ability to control and adjust the aging process of individual barrels; and

provide a system for predicting if a barrel will meet desirable aging process parameters.

These and other advantages may be realized by reference to the remaining portions of the specification, claims, and abstract.

### BRIEF DESCRIPTION OF ONE EMBODIMENT OF THE PRESENT INVENTION

A aging barrel such as for wine, whiskey and the like may include a sensor assembly disposed in the bung for sensing parameters from within the barrel. A transceiver sends the signals to a computer system which analyzes the signals and determines if the parameters of the barrel have reached or are trending toward an abnormal barrel profile. Alerts may be sent to end users, e.g. via SMS or email, to enable corrective action to be taken. In one example, a temperature profile of multiple barrels within a storage facility may be obtained and barrels may be moved to achieve desired temperature characteristics.

In one aspect, the invention provides a system for monitoring a barrel containing an aging alcoholic beverage. The system includes at least one bung for a barrel in which is embedded one or more sensors. The sensor(s) transmit signal(s) to a computer system that determines if an abnormal barrel profile is present and sends an alert to an end user if required.

In one aspect, there is provided a method for monitoring a barrel containing an aging alcoholic beverage. The method transmit one or more signals from one or more sensors disposed in a barrel bung to a computer system. The computer system determines if an abnormal barrel profile is present and sends an alert to an end user if required.

In one aspect, there is provided a system for monitoring a barrel containing an aging alcoholic beverage. The system includes bung means for a barrel and sensor means within the bung means for sensing at least one signal. The system includes transmitter means for transmitting the signal to a processor means, which determines if an abnormal barrel profile exists. If an abnormal barrel profile is present, the processor means generates and sends an alert signal to an end user.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a side view of the barrel bung sensor assembly;

FIG. 2 is a view of a gateway that includes a transmitter/receiver used to communicate with barrel bung wireless transmitter/receiver;

FIG. 3 is a flow diagram in which the barrel bung sensor assembly gathers sensor data for processing; and

FIG. 4 is a software architecture diagram that executes on a processor system.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present application describes a method and system for incorporating a fluid level sensor and temperature sensor within a wine and whiskey barrel bung that communicate sensor data wirelessly to a gateway connected to a data network. The wine and whiskey barrel bung sensor data can be used to monitor the headspace within the barrel and alert wine and whiskey operations of potential leaks and headspace status. The wine barrel bung sensor can also monitor temperature of the wine or whiskey during the aging process. Active monitoring alerts technicians of any fluid and temperature anomalies. Sensor data can be used with a monitoring service, mobile phone application, custom software, or with existing systems.

The barrel bung sensor pack may include a number of types of sensors used to collect environmental data, such as those used to measure detect PH, oxygen, sulfur oxides, and others. The data collected is used to build a data profile which can be subsequently used to predict potential abnormalities, alerting if a barrel needs to be examined for further testing.

In addition, an array of sensors may be connected to the barrel bung sensor pack to monitor a range of environmental attributes, such as PH, sulfite levels, oxygen, and others. The data from these sensors is used to build a data model of the barrel environment over time, creating a data pattern or profile that can be used to create a “good” profile for a specific wine or whiskey aging process. The data profiles are used to identify deviations from a good profile. Additionally, the data gathered from the barrel bung sensor pack can be used in predictive modeling, employing predictive modeling methods, such as Logistic Regression and others. Logistic Regression predictive modeling uses one or more known discrete variable values to predict a discrete unknown variable. In this way the invention can predict a potential issue with wine or whiskey in a barrel during the aging process. Logistic Regression is simple to use in this invention because of its binary nature to identify a potentially “bad” profile based on comparisons of historical data profiles.

The nature of wine and whisky productions lends itself to part science and part art as wine and whisky makers develop processes and technique that are designed to elicit specific attributes that differentiate the wine or whiskey in the marketplace. In one embodiment, the present invention is designed to enable the feedback from the end user to influence the ideal barrel data profile to which all barrels of a varietal are compared. The end user feedback is important for both varietal batch processes, such as aging profile differences Chardonnay (white wine) and Cabernet Sauvignon (red wine), and historical trending evaluations of good and bad barrels. In this way, if there is a barrel that is identified as bad, the data profile of that barrel can be used as a data pattern to compare all current and future barrels. There are many predictive models that can be used to compare and predict potential bad barrels, one of the simplest that can be implemented for this invention is Logistic Regression, a technique where an unknown value(s) of a discrete variable is predicted based on known values of one or more continuous or discrete variables. Other models may be more applicable for a combination of sensor and types for discrete and continuous variables. These other predictive models may include semiparametric regression, robust regression, generalized additive models, k-nearest neighbor algorithm, random forest, and others. The purpose of employing predictive models is to create a self-improving process where a number of discrete variables can predict a potential problem with a barrel during the aging process. For example, Sulfite levels in wine are very important—too low and spoilage can occur, too much and a wine may develop unfavorable attributes. The current state of Sulfite testing does not lend itself to testing every barrel on a regular basis, it is too costly and time intensive. The predictive modeling of embodiments of the present invention may be used to identify barrel data profiles that may be abnormal or are starting to become abnormal based on historical profile comparisons of bad barrels. In this way, wine and whisky making processes that utilize these methods have the means to measure a range of environmental conditions to improve process quality and reduce wine and whisky loss.

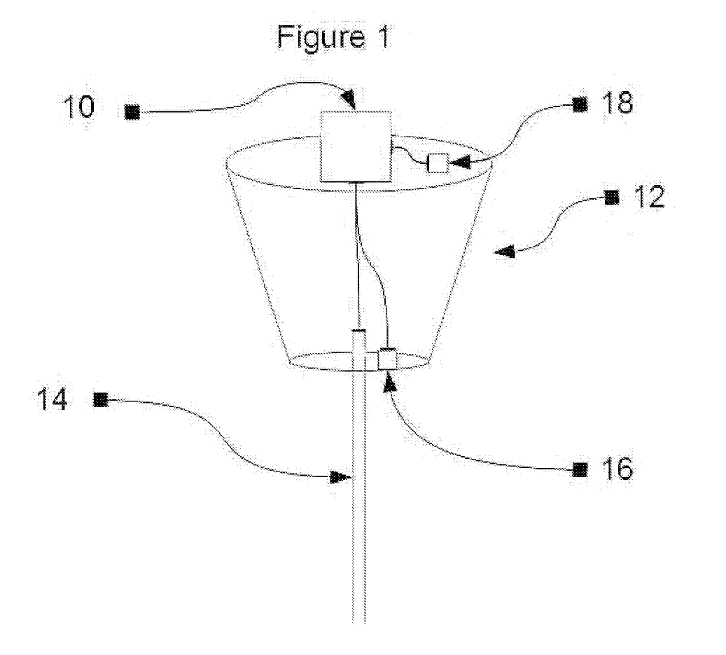

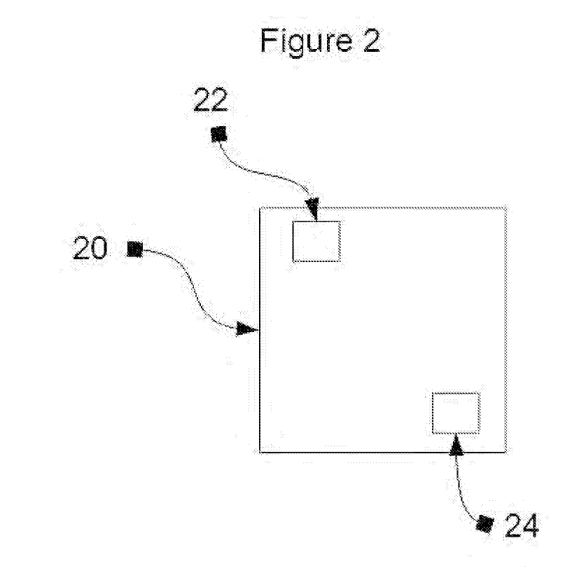

FIG. 1 illustrates a fluid level sensor 14 and a temperature sensor 16 embedded in a barrel bung 12 that may be comprised of a food grade material such as silicone, polymer or other material suitable to molding. The sensors 14, 16 project from the inner surface of the bung such that, in use, they are exposed to the internal cavity of a barrel. The sensors 14, 16 are connected to a radio enabled transmitter/receiver 10 that communicates with custom or standard wireless protocols such as Zigbee, Bluetooth, Zwave, WiFi (802.11) or other wireless communications protocol that may be embedded in the barrel bung 12 or attached to the top of the barrel bung 12. The radio enable transmitted/receiver 10 is suitable to communicate with a gateway 20 depicted in FIG. 2. Additional environmental sensors 18, such as humidity, light, pressure, or other may also be connected to radio enabled transmitter/receiver 10 and may protrude from an outside surface of the barrel bung. The barrel bung wireless sensor pack collects and communicates readings to a system that can be used to monitor and store the readings, such as a database.

The radio enabled transmitter/receiver 10 provides power and a wired connection to sensors 14, 16, 18. The transmitter/receiver 10 and the sensors 14, 16, 18 may be powered from a power source (not shown) such as a battery or by a mains connection via a transformer. The sensors may provide measurements in the form of a low voltage, e.g. 0 to 5 Volts DC or 0 to 10 Volts DC as a resulting measurement which is communicated to the gateway 20 by the transmitter/receiver 10.

The fluid level sensor and temperature sensors may be any one of the many known sensors suitable for the present purposes and thus no further description of the sensors is considered necessary herein.

The component 10 is described herein as a transmitter/receiver or transceiver having both transmit and receive functions. The receive function is required for receiving polling requests as will be described in more detail below. In an alternative embodiment, the transceiver may be a transmitter only and will convey signals periodically without responding to a polling request.

FIG. 2 illustrates a gateway that communicates with barrel bung radio enabled transmitter/receiver 10 in order to send sensor data by means of custom or standard wireless protocols, such as Zigbee, Bluetooth, Zwave, WiFi (802.11) or other wireless communications protocol. The gateway 20 includes a wireless transmitter/receiver 22 capable of communicating with the barrel bung sensor radio enabled transmitter/receiver 10 for receiving sensor signals. Sensor data is transmitted from the barrel bung sensor to the gateway 20, and then communicated through a network connection 24 that may be wired or wireless, such as Ethernet and TCP/IP. The gateway 20 may have an embedded web server including at least one processor and a memory for storing instructions executable by the processor for performing the functions of the web server and/or the transmitter/receiver functions. The web server may enable various communication protocols such as ModbusTCP, ModbusRTU, XML, Json, or other standard or custom communications protocol.

The gateway 20 can be configured to set polling times to request sensor readings from the radio enabled transmitter/receiver 10. The gateway 20 polling frequency can be configured directly or through another connected system, such as a control system or building management system. The gateway sends a polling request to the radio enabled transmitter/receiver 10, where the level sensor 14 and temperature sensor 16 send signal data to the radio enabled transmitter/receiver 10. The radio enabled transmitter/receiver 10 transmits the signal readings to the gateway 20 that can be accessed or sent to another system, such as a control system or building management system.

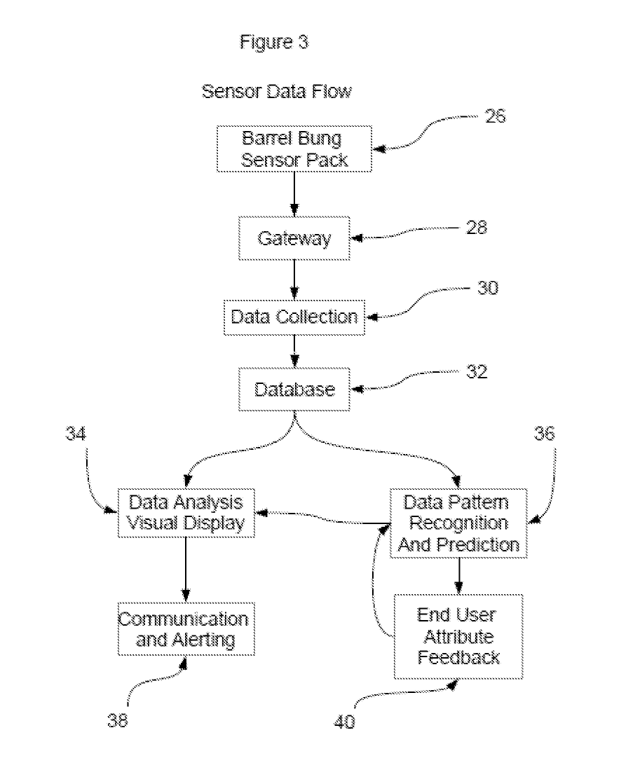

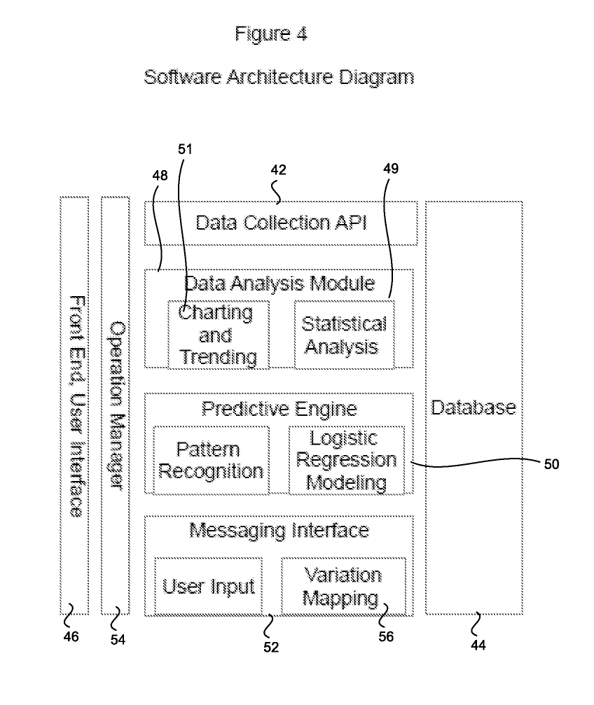

FIG. 3 illustrates the flow of sensor data through the process components of the invention while FIG. 4 illustrates an embodiment of a software architecture for implementing the data flow. The software architecture of FIG. 4 may be implemented on a computer system including at least one processor and at least one operatively associated memory that stores software instructions or code that can be implemented by the at least one processor. The processor(s) may be in an integrated or distributed environment as required. Sensor data collected through the Barrel Bung Sensor Pack 26, i.e. the fluid level sensor 14, temperature sensor 16 and environmental sensor(s) 18, includes data input from environmental sensors such as temperature, light, and humidity outside the barrel, as well as temperature, fluid level, PH, sulfite, oxygen, and potentially other sensor data. The sensor data is transmitted to the gateway 28 where it may be stored temporarily until the data collection 30 process occurs through the Data Collection API 42. Environmental Sensor Data is written to a database 44 and used by the Data Analysis Visual Display 34 and the Data Pattern Recognition And Prediction 36 processes. The Data Analysis Visual Display 34 defines barrel profiles based on sensor data from the database 32 and provides a data object suitable for visual rendering through the Front End, User Interface GUI 46. The Data Pattern Recognition And Prediction 36 uses defined barrel data profiles to identify good and potentially bad barrel data profiles. The End User Attribute Feedback 40 receives input from the end user through the Front End, User Interface 46 for setting weighed variables, such as temperature, PH, fluid level, or oxygen variation thresholds.

The environmental data is used by the data analysis module 48 for Statistical Analysis 49 as well as Charting and Trending 51 that may be rendered through the Front End, User Interface 46 in GUI format easily readable by humans. Environmental data is also used by the Predictive Engine 50 which employs pattern recognition in barrel profile data as well as utilizes a predictive model, such as Logistic Regression modeling to identify if there is a pattern matching abnormal barrel data profiles. Any abnormal or predicted abnormal barrel data profile identified is sent to the Messaging Interface 52 and email, SMS, GUI rendering, and other communication methods are used to alert the wine or whisky maker. The Operation Manager 54 directs operations between the Data Collection API 42, Data Analysis Module 48, Predictive Engine 50, and Messaging Interface 52 components. The software can be coded in a number of programming languages, such as Python, JAVA, C+ and others. Python lends itself to be modular and has a history of good performance with interfacing databases and applying complex mathematical processes.

The software gathers and processes the sensor data and presents information in a usable and beneficial form. The software can be used as a service or as a standalone implementation with modular components residing on premises or in the data cloud, such as the database, predictive engine, or other invention process component. The database can be a relational SQL, NoSQL, or other such as object-oriented.

The Messaging Interface connects end user input through the GUI front end interface to weighted variables on the Variation Mapping component 56. The Variation Mapping component 56 enables tweaking of varietals used in the Data Analysis module definition of barrel data profiles. The Pattern Recognition component of the Predictive engine is used to match known good barrel profiles with varietals based on good historical barrel profiles and Variation Mapping from end user input.

Monitoring the environmental variables with a barrel bung sensor pack enables the wine and whisky makers to identify data patterns for ideal barrel aging conditions. Historical data trending enables the predictive alerting of when a pattern begins to deviate from a defined “good” barrel profile, initiating an alert recommending that a barrel may need to be tested in greater detail. Predictive alerting can identify a need for corrective action before static comparisons can, thereby maintaining the barrel profile towards its most desirable.

There is a need to monitor temperatures in each barrel in order to improve quality during the aging process. Temperature data can be used to improve quality of the aging process, alerting operational managers if temperature deviates from prescribed process parameters. Barrels are generally stored in an environmentally controlled facility, where HVAC systems are controlled through a thermostat. Environmental control through a thermostat does not accurately maintain consistent temperature throughout a facility because barrels closer to HVAC duct work will receive significantly more thermal energy (heating or cooling) based on the location of the HVAC thermostat. Consistent temperature is important for the aging of wine and whiskey, barrels can be strategically rotated near duct work in order to maintain consistency. In addition, added duct work may be implemented with dampers and utilized through a control system to evenly distribute thermal energy produced by the HVA system. Sensor data can be used to correlate a thermal map of barrels and spatial positioning that can be used to optimize the physical facility structure to be optimized for thermal energy disbursement.

Using the above described monitoring and prediction processes, the described system can be used to confirm that the intended environmental process variables are achieved and/or alert the wine or whisky maker that a problem may or will potentially exist with a barrel during the aging process.

While particular description has been provided of wine and whiskey production, the person skilled in the art will recognize that the systems and methods described herein can be applied equally to barrels containing a wide variety of aging fluids.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A system for monitoring a barrel containing an aging alcoholic beverage, the system comprising:
(A) at least one bung for a barrel;
(B) at least one sensor disposed in the bung and penetrating to the internal cavity of the barrel, the at least one sensor adapted to generate at least one sensor signal;
(C) at least one transmitter operatively connected to the at least one sensor to receive the sensor signal, the at least one transmitter configured to transmit the at least one sensor signal; and
(D) a computer system comprising at least one processor, the at least one computer system configured to:
(a) receive the at least one sensor signal;
(b) determine if the at least one sensor signal corresponds to at least one abnormal barrel profile; and
(c) if the abnormal barrel profile is determined, generate an alert and send the alert to at least one end user.

2. The system of claim 1 wherein the computer system sends the alert by at least one of email or SMS.

3. The system of claim 1 wherein the abnormal barrel profile is a predicted barrel profile based on a trend of the at least one sensor signal.

4. The system of claim 1 wherein the at least one sensor comprises a fluid level sensor and a temperature sensor embedded in the bung.

5. The system of claim 4 comprising at least one environmental sensor configured to sense at least one environmental parameter outside of the barrel, the computer system configured to use the at least one environmental parameter to determine if the abnormal barrel profile exists.

6. The system of claim 1 wherein the computer system is programmed to perform a data pattern recognition and prediction process to determine if an abnormal barrel profile exists.

7. The system of claim 6 wherein the computer system comprises at least one database that stores a plurality of defined barrel profiles and wherein the data pattern recognition and prediction process references the plurality of defined barrel profiles.

8. The system of claim 6 wherein the data pattern recognition and prediction process is programmed to predict if a current barrel profile of the barrel is trending toward an abnormal barrel profile.

9. The system of claim 6 wherein the data pattern recognition and prediction process is programmed to process a temperature signal and determine if a spatial position of the barrel needs to be moved within a facility.

10. A method for monitoring a barrel containing an aging alcoholic beverage, the method comprising:
(A) at least one bung for a barrel;
(B) sensing at least one sensor signal by at least one sensor disposed in a bung of the barrel and penetrating to the internal cavity of the barrel;
(C) transmitting the at least one sensor signal to a computer system comprising at least one processor;
(D) determining, by the computer system, if the at least one sensor signal indicates at least one abnormal barrel profile; and
(E) if an abnormal barrel profile is indicated, generating an alert and sending the alert to at least one end user.

11. The method of claim 10 comprising sending the alert by at least one of email or SMS.

12. The method of claim 10 comprising predicting an abnormal barrel profile based on a trend of the at least one sensor signal.

13. The method of claim 10 comprising sensing a fluid level and a temperature within the barrel.

14. The method of claim 13 comprising sensing at least one environmental parameter outside of the barrel and using the at least one environmental parameter to determine if the abnormal barrel profile exists.

15. The method of claim 10 comprising performing a data pattern recognition and prediction process to determine if an abnormal barrel profile exists.

16. The method of claim 15 wherein the data pattern recognition and prediction process comprises referencing a database of defined barrel profiles.

17. The method of claim 15 comprising predicting if a current barrel profile of the barrel is trending toward an abnormal barrel profile.

18. The method of claim 15 wherein the data pattern recognition and prediction process comprises processing a temperature signal and determining from the temperature signal if a spatial position of the barrel needs to be moved within a facility.

19. A system for monitoring a barrel containing an aging alcoholic beverage, the system comprising:
(A) bung means for a barrel;
(B) sensor means within the bung means for sensing at least one sensor signal;
(C) transmitting means for transmitting the at least one sensor signal; and
(D) processor means for receiving the at least one sensor signal, determining if the at least one sensor signal corresponds to at least one abnormal barrel profile, and if the abnormal barrel profile is determined, generating and sending an alert to at least one end user.

20. The system of claim 19 comprising means for predicting if a current barrel profile is trending toward an abnormal barrel profile.
